(19) United States
(12) Patent Application Publication
(10) Pub. No.: US 2007/0181068 A1
(43) Pub. Date: Aug. 9, 2007

(54) Method and system for automatically feeding animals

(76) Inventor: Daniel B. McKeown, Fergus (CA)

Correspondence Address: DARYL W SCHNURR;MILLER THOMSON LLP, ACCELERATOR BUILDING, 295 HAGEY BLVD., SUITE 300, WATERLOO, ON, N2L 6R5, CA

(21) Appl. No.: 10/599,764

(22) PCT Filed: Apr. 8, 2005
(86) PCT No.: PCT/CA05/00535

§ 371 Date: Oct. 6, 2006

Related U.S. Application Data
(60) Provisional application No. 60/560,036, filed on Apr. 8, 2004.

(51) Int. Cl. A01K 5/02

(52) U.S. Cl. 119/51.02

(57) ABSTRACT

A method and system for automatically feeding animals uses identifiers on the animals and controls access to one or more food sources to control the amount consumed by each animal. The system is controlled by a programmable processor and can provide or prevent access and cut off access once provided based on the particular animal seeking food.

### BACKGROUND OF THE INVENTION

1. Field of the Invention

This invention relates to a method and system of automatically feeding animals whereby the amount, type of food and frequency of feeding is controlled and monitored for each animal of several animals being fed by the same system.

2. Description of the Prior Art

Automatic feeding systems for animals are known. Some, previous systems can record the amount of food consumed by each animal but cannot control the amount of food consumed. One previous system is described in Lanfranchi U.S. Pat. No. 5,669,328. The Lanfranchi patent describes an automatic animal feeding system containing one feed bowl whereby one animal having particular diet requirements, is given access to a feeding dish within a conical-shaped protective cover whenever the animal comes within a predetermined distance of the system. Other animals are not allowed access to the feed dish. This system does not monitor the amount of food consumed by the animal or the number of times that the animal accesses the food or the time of day that the animal consumes the food. The system cannot be used to feed the remaining animals, but only the animal with particular dietary requirements.

### SUMMARY OF THE INVENTION

It is an object of the present invention to provide a system and method for automatically feeding animals where the amount of food consumed by each animal is monitored and controlled automatically by the system. Further, it is an object of the present invention to provide a method and system of automatically feeding animals where there is more than one source of food and the type of food is monitored and controlled for each animal. It is still a further object of the present invention to provide a method and system for automatically feeding animals where the frequency of feeding is monitored and controlled and the system is able to monitor which food source is first approached and which food source is first tasted by each animal. It is a further object of the present invention to provide a system and method for where the time of day that feeding is permitted is controlled and automatically feeding animals where several animals are monitored and fed by the system.

A method of feeding animals using an electronic system having a feeding station with at least one food source, said station being controllable by a programmable processor, said method comprising locating an electronic locating device on each animal to enable each animal to be individually identified by said system, placing said at least one food source in a controlled access location, controlling access to said at least one food source by each animal separately, storing information from each feeding and using at least some of said stored information for a subsequent feeding.

A method of feeding animals uses an electronic system having a feeding station with one or more controlled access feed sources. The station is controlled by a programmable processor, the programmable processor being connected to a reader. The reader is capable of identifying a distinct feature of each animal, said animals each having a distinct feature that can distinguish the animals from each other. The method comprises pre-programming a feeding program for each animal, using said reader to identify each animal that approaches said station, placing said one or more feed sources in a controlled access area of said system, locating an access barrier for each feed source, automatically controlling access to said feed sources for each animal in accordance with said feeding program for each animal including the type and amount of feed consumed by opening and closing said barrier or barriers appropriately storing information for each feeding for each animal.

An automatic feeding system for animals comprises a feeding station with at least one feed source. The station is controlled by a programmable processor. The animals have individual identifiers mounted thereon. The feed source is located in a controlled access area, the access being controlled by a barrier. There is one barrier for each feed source, the processor controlling each barrier based on information for each animal. The processor identifies each animal and opens and closes each barrier for each feed source to allow access or prevent access to each food source for each animal, determines the type and amount of each food source consumed by each animal, and stores information from a feeding in a memory.

A feeding system for animals comprises a feeding station with at least one feed source. The animals each have a distinct feature that can distinguish the animals from each other. The feeding station is controlled by a programmable processor, the programmable processor being connected to a reader. The reader is capable of identifying the distinctive feature of each animal. The processor automatically controls access to the at least one feed source by each animal. The system is constructed to open and close a barrier between the animals and the at least one feed source. The system has a memory to store information for each animal for several feedings.

### BRIEF DESCRIPTION OF THE DRAWINGS

FIG. 1 is a perspective view of a feeding system having two bowls;

FIG. 2 is a front view of said feeding system;

FIG. 3 is a partial perspective view from a front of said system with an open back;

FIG. 4 is a partial perspective view of said system from a rear with an open back;

FIG. 5 is a partial top view of said system;

FIG. 6 is a partial side view of said system;

FIG. 7 is a partial perspective view of said system with a closed back;

FIG. 8 is a perspective view of part of said system;

FIG. 9 is a perspective view of one bowl mounted in said system;

FIG. 10 is a perspective view of said system when viewed from a rear;

FIG. 11 is a perspective view of said system with a tunnel removed;

FIG. 12 is a perspective view of a further embodiment of a feeding system with an open cover;

FIG. 13 is a perspective view of the feeding system with a closed cover;

FIG. 14 is a perspective view from a rear;

FIG. 15 is a partial perspective view of the feeding system with components deleted to expose an interior;

FIG. 16 is a partial perspective view of part of said feeding system;

FIG. 17 is a front view of said feeding system;

FIG. 18 is a side view of said feeding system; and

FIG. 19 is an automatic feeding system having two modules located side by side relative to one another with each module having one feed source.

### DESCRIPTION OF A PREFERRED EMBODIMENT

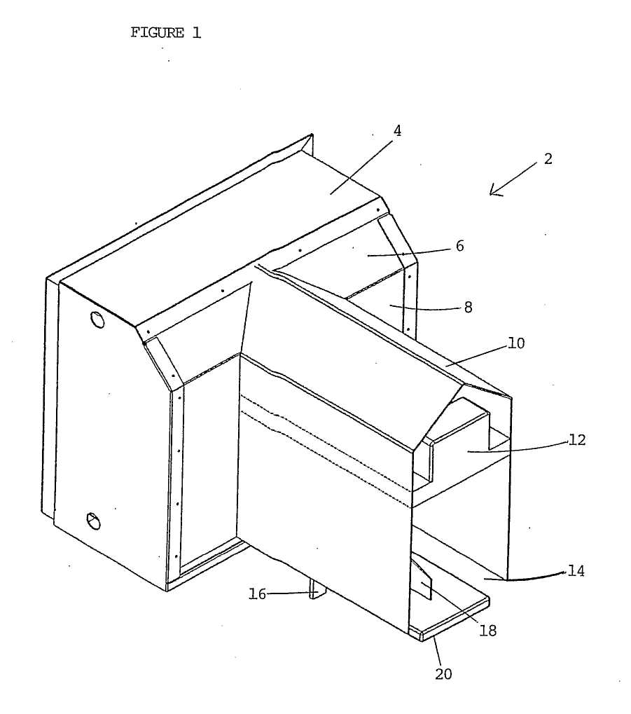

In FIG. 1, there is shown a perspective view of one embodiment of an automatic feeding system having a main housing 4 with a Plexiglas (a trademark) front 6, 8. Other materials will also be suitable for the front 6, 8, including other plastics. It is preferred that the front be transparent (or at least translucent) to allow the containers to be seen from outside the system. If an opaque front is used, warning lights or alarms can be employed to determine if a feed source is empty or if the system is not functioning properly. A tunnel 10 extends out a front of the housing 4. The tunnel 10 defines a pathway to gain access to the feeding system 2. A reader 12 is located at an entrance 14 of the tunnel 10. A scanner 12 is located at the entrance 14. The tunnel has a baffle 16 and a central ridge 18. The ridge 18 extends through the baffle 16 and is purposely designed to be uncomfortable to an animal within the tunnel so that it is unlikely that an animal will remain in the tunnel after the feeding process has been completed and thereby prevent other animals from accessing the feeding system 2. The weigh scales 20 is located beneath the baffle 16 and the ridge 18.

In FIG. 2, the same reference numerals are used as those used in FIG. 1 for those components that are identical. The baffle 16, which is located approximately half way along the tunnel (not shown in FIG. 2) has a central opening 22 that is sized to allow an animal (not shown) to pass through the opening. Only one animal can pass through the opening 22 at any given time. There is a first feed source 24 and a second feed source 26 located within the housing 4. The feed sources 24, 26 are each mounted on a load cell 30. When one animal has passed through the opening 22 and is occupying a space between the baffle 16 and the feed sources 24, 26, there is no room for a second animal. Each feed source 24, 26 is contained in a container 27 and each container 27 has a rotatable cover 32 thereon. Each cover 32 has an opening 36 therein. Sensors 38 on each cover 36 sense which container the animal goes to first and whether the system is operating properly. Sensor 39 senses whether an animal is within the tunnel. A servo motor (not shown in FIG. 2) is connected to each cover and to a programmable processor 40 which operates the system. The scanner 12 is also connected to the programmable processor 40, as are the sensors 38, 39.

The feeding system 2 is used to feed a plurality of animals (not shown) with each animal having a distinctive feature that allows the animal to be identified. The distinctive feature can be an electronic chip embedded in a collar on the animal or embedded under the skin of the animal. The distinguishing feature can also be a distinctive transmitter on each animal. Further, the distinctive feature can be the retina or iris of each animal. The scanner 12 can also be described as a reader. The scanner 12 is used to identify the animal by recognizing the distinguishing feature on the animal. Various electronic devices can be used to identify the animal. The scanner 12 identifies the animal as it approaches the tunnel 10. When the animal is within the tunnel, the weigh station 20 weighs the animal. The weigh station 20 is connected to the processor 40. The processor 40 has a memory to record many variables, for example, the weight of the animal, the time of the feeding, which container the animal first approached, which container the animal first consumed feed from, how much feed of each type was consumed, whether an animal is within the tunnel and the weight of the animal after the feeding. When the covers 32 rotate to the position shown in FIG. 2 with the openings 36 extending forward and inward, the feed sources are in an open position.

The programmable processor 40 can be a processor in a computer with a memory and display monitor or other display. Other programmable processors can be used that are not computers. The programmable processor must have a memory and preferably a flash memory. Also, the programmable processor is preferably networkable and can have a display or printer or some other means for obtaining output from the processor. There can be multiple feed stations and the stations can be controlled by multiple personal computers that are networked to one another or each station can have a built-in processor to eliminate the personal computers. Alternatively, the multiple feed stations can each be controlled by a computer or processor that is independent of the computer or processor for each of the other stations. Each station can be programmed to monitor and feed a portion of the animals in the group of animals being monitored and fed by the stations. For example, if thirty cats are being fed by three stations, each station would be set up to feed ten cats. The first group of ten cats would only be able to eat at the first station, the second group of ten cats would only be able to eat at the second station and the third group of ten cats would only be able to eat at the third station. The programmable processor must be able to accept multiple scanners, multiple DC voltage outputs with USB. RS232 or RS 485 ports. Feeding stations can be placed right on the floor, through a wall or on a raised surface. Preferably, a feeding station will be capable of operating independently and be capable of operating as part of a network controlled by a computer. The feeding system can be designed to operate independently of a computer having a monitor, and keyboard where the computer is only connected to the feeding station to record or display data saved in the memory of the programmable processor. A printer on the computer is required if one wishes to print reports from the system. The software that operates the system allows data for each animal to be stored and/or printed as desired. The feeding station can also contain a modem (not shown) so that it can be monitored remotely and amendments to the feeding program of any of the animals being fed by the station or monitored by the station can be made remotely.

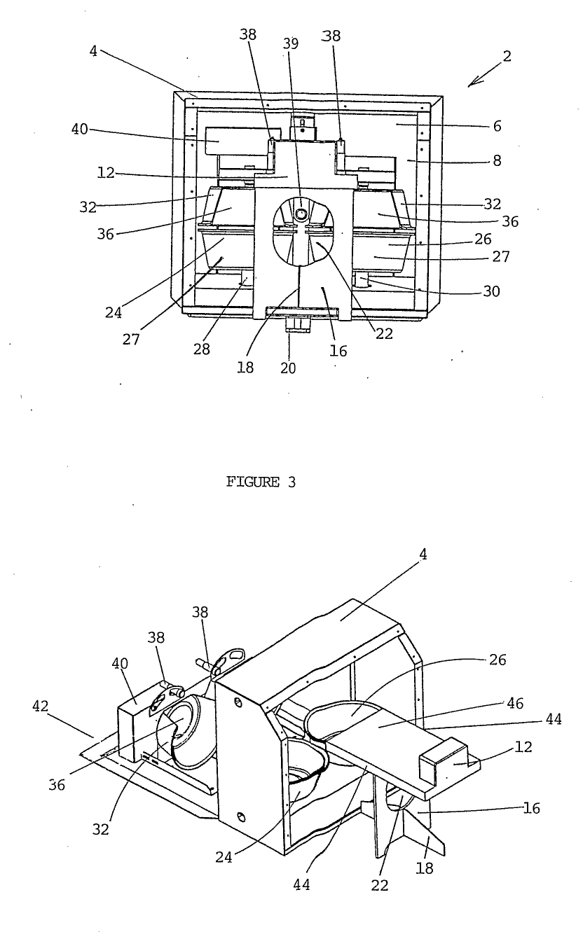

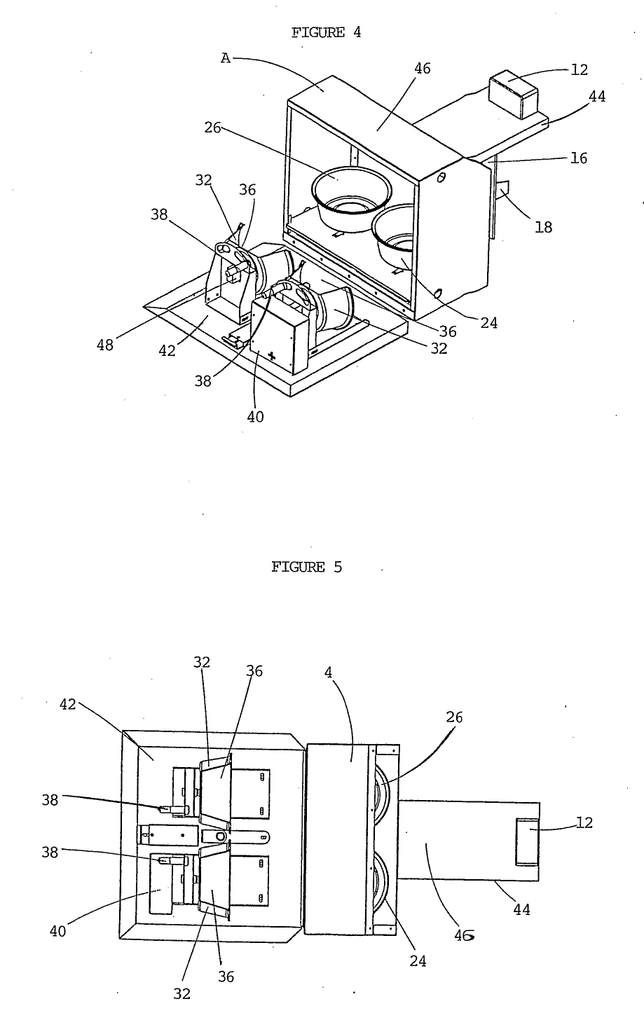

In FIGS. 3, 4 and 5, an outer portion of the tunnel 10 has been removed and a back 42 of the housing 4 is open. It can be seen that the containers 27 are accessible by opening the back 42 to allow the containers to be refilled with feed (not shown). While the system operates automatically, the feed sources are filled manually. The scanner 12 has an antenna 44 extending along a periphery of a ceiling 46 in the tunnel (not shown in FIGS. 3, 4 and 5). The same reference numerals are used in FIGS. 3, 4 and 5 as those used in FIGS. 1 and 2 to describe those components that are identical. A servo motor 48 for one of the covers 32 is shown. The servo motor for the other cover is hidden by the sensor 38 or processor 40. The processor 40 can be a mini computer or microprocessor. The processor 40 can be connected to a computer to download software onto the processor or to provide commands to the processor or to change the feeding program of one or more of the animals. Preferably, the processor has a built in flash memory.

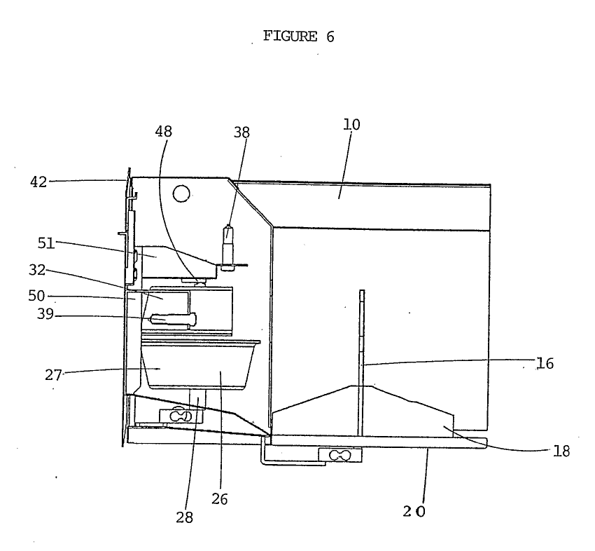

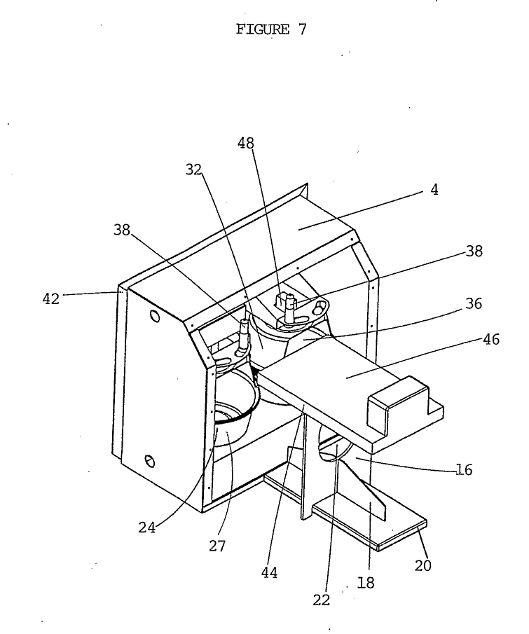

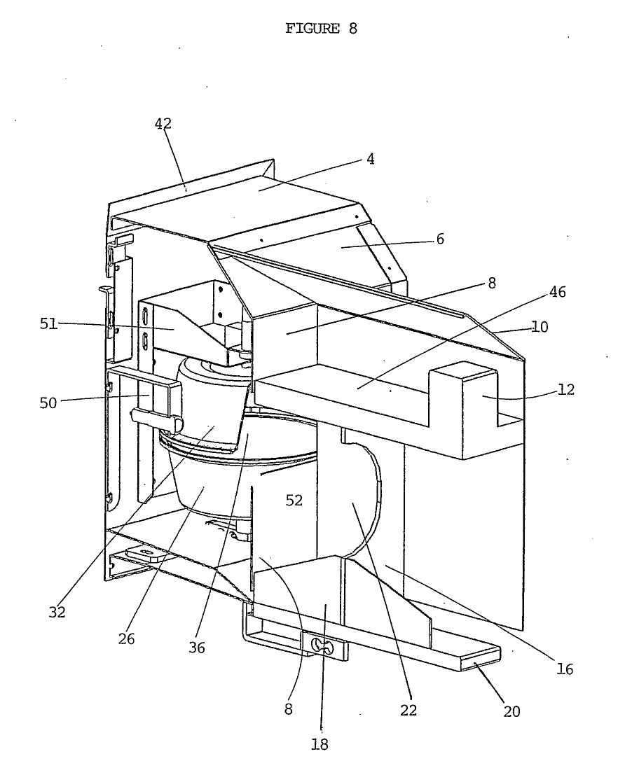

In FIG. 6, there is shown a side view of one of the containers 27 in the housing 4 and half of the tunnel 10 (the scanner, antenna and ceiling are not shown in FIG. 6). The back 42 is closed and there are brackets 50, 51 to support the servo motors 48 and sensors 38. The covers 32 are screwed directly onto the servo motors 48 by screws (not shown). In FIGS. 7, 8 and 9, there is shown various perspective views of part of the feeding system 2. The same reference numerals are used in FIGS. 6, 7, 8 and 9 as those used in FIGS. 1 to 5 for those components that are identical.

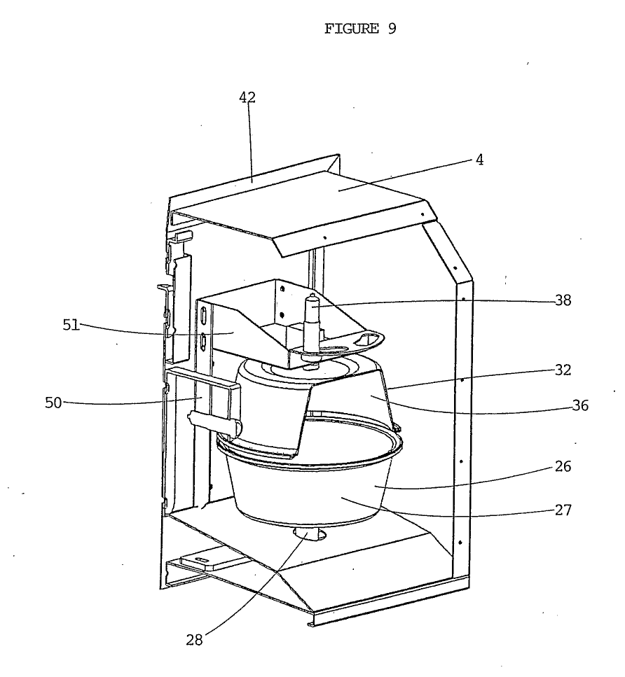

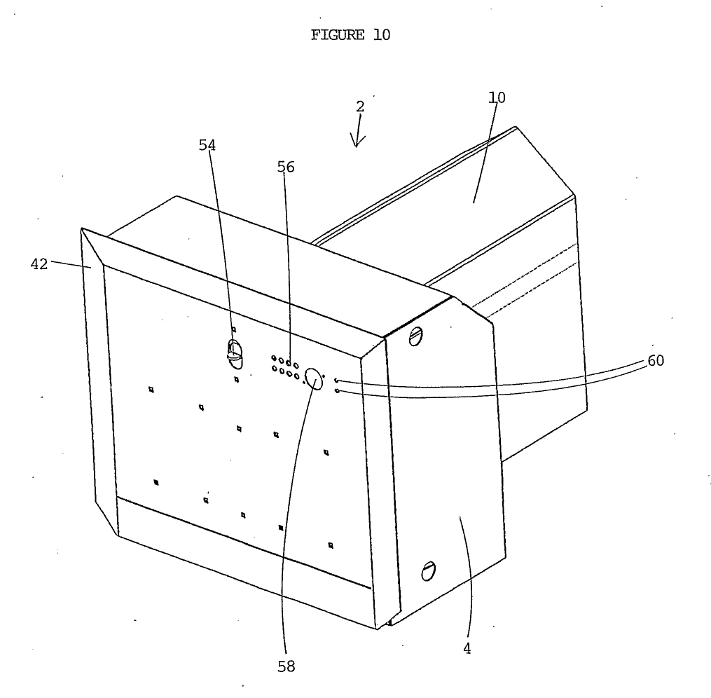

From FIG. 8, it can be seen that, in addition to the oval opening 22 in the baffle 16, there is a second opening 52 in the Plexiglas front 8 of the housing 4. An animal accessing feed from one or both of the containers 27 will pass through the oval opening 22 within the tunnel 10 and access the open container 27 through the opening 36 in the cover 32. In FIG. 9, the cover 32 has turned away from the second opening 52 in the front 8 (not shown in FIG. 9) so that the cover 32 has moved toward a closed position. The scanner 12, which can also be a reader, can be a photocell or a proximity meter, which will identify the animal and, depending on the information pre-programmed into the processor, will either remain in the closed position for that animal or will provide access to one of the two feed sources 24, 26 by causing the cover on that feed source to rotate about the circumference of the container 27 until the cover has rotated far enough to allow the animal access to that feed source. Alternatively, for a particular animal, both feed sources will remain closed and inaccessible to that animal for a particular feeding.

Since the feed source is constantly being weighed, the amount of food that is being consumed by each animal will be determined and the information will be stored in memory. The animal is also weighed immediately before and after it eats and those weights are also recorded. As the animal approaches its limit for the amount of food to be consumed at that feeding, the cover 32 of that feed source will be automatically moved from the open position to the closed position. For some animals, access may be permitted to both of the feed sources in sequence or simultaneously. As each animal approaches the feeding station, the processor will determine whether or not that animal will be permitted to eat anything, the type of food (i.e. from feed source 24 or feed source 26 or both) that the animal will be able to consume and the amount of feed that the animal will be able to consume. The system will also monitor the number and frequency of feedings within a given time period and will prevent further access to the feed sources for those animals that have consumed their limit for that particular time period. The system can also control the time of day when each animal will be allowed to eat and a number of feedings allowed for each animal in a particular time period. For example, if an animal is to eat twice per day, the system can be programmed to allow the animal to eat during two periods only. If an animal misses a scheduled feeding, the system can be programmed to automatically extend the time period.

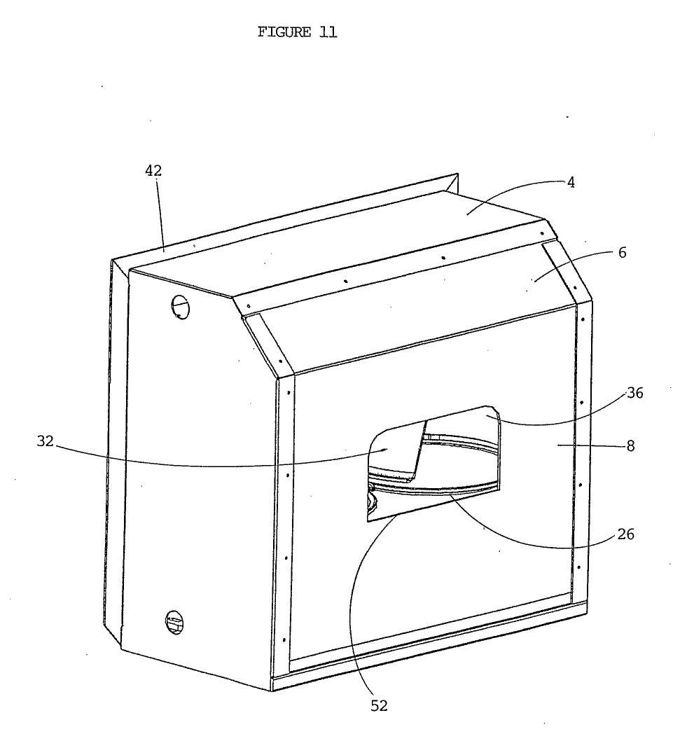

In FIG. 10, a perspective view of the feeding system 2 is shown with the back 42 in a closed position. A latch 54 locks the back 42 relative to the housing 4. The latch can be locked so that it cannot be accidentally opened by any of the animals. A plurality of LED's 56 represent indicator lights that monitor the operation of various parts of the system and change colour when any of those parts malfunction. An audio speaker 58 allows verbal commands or other audio input to be given to the animals. Control switches 60 allow the system to be shut down before the back 42 is opened and reactivated when the back 42 is closed. The back can be connected to automatically shut down the system when it is opened. In FIG. 11, the tunnel has been removed from the Plexiglas front 8 of the housing 4. The shape of the second opening 52 in the Plexiglas front 8 is clearly shown in FIG. 11. The same reference numerals are used in FIGS. 10 and 11 as those used in FIGS. 1 to 9 to describe those components that are identical.

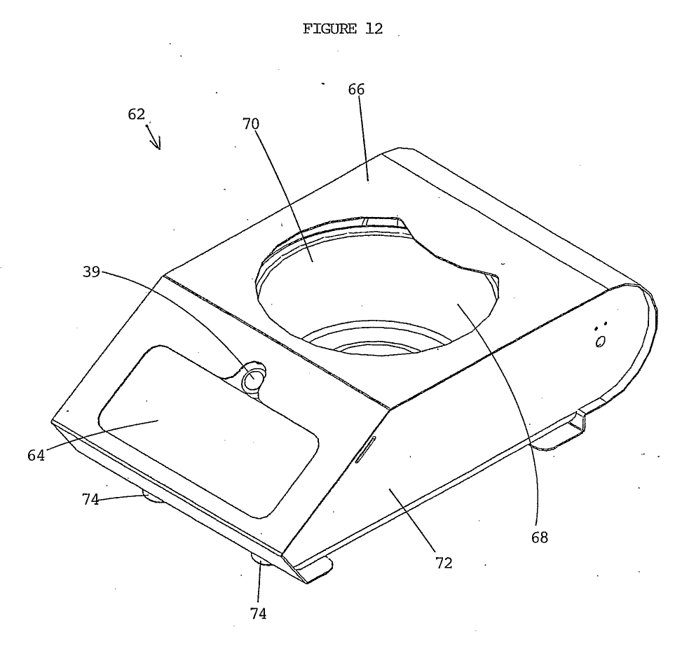

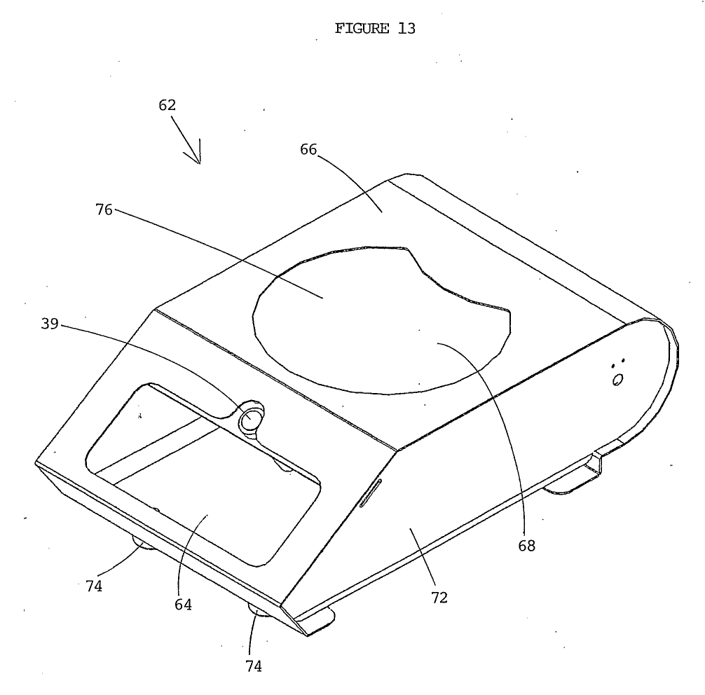

In FIGS. 12 and 13, there is shown a perspective view of a further embodiment of a feeding system 62 having a Plexiglas front 64 for housing a reader (not shown in FIGS. 12 and 13) and programmable processor (not shown in FIGS. 12 and 13). The feeding system 62 has a top surface 66 with an irregularly shaped opening 68 therein. A container 70 is located beneath the opening 68. The feeding system 62 has two sides 72 with four legs 74 (only two of which are shown) thereon. In FIG. 12, a sliding door (not shown) is open to allow access from the exterior of the system 62 to feed (not shown) within the container 70. A sensor 38 determines whether there is an animal at the feeding system. When an animal is feeding, the door will remain open until the animal reaches its consumption limit for that feeding. In FIG. 13, the door 76, which slides beneath the top surface 66 is in the closed position and prevents access to the container 70 from outside the feeding system 62.

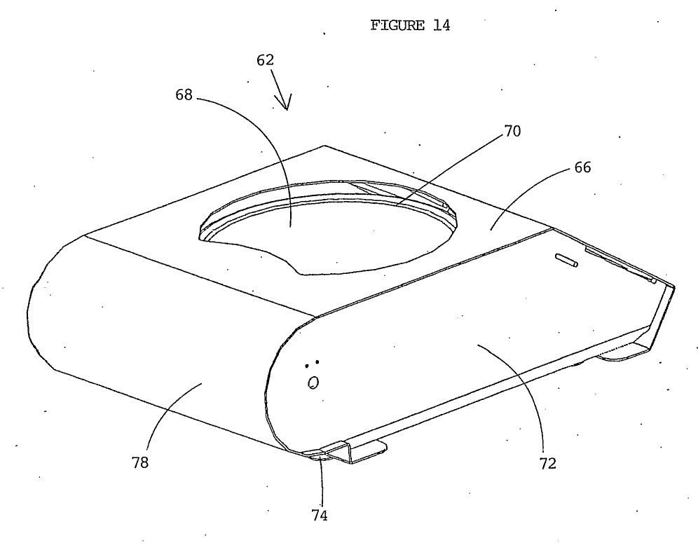

In FIG. 14, there is shown a perspective view of the feeding system 62 when viewed from a rear 78. The door (not shown in FIG. 14) is in the open position.

In FIG. 15, the top surface 66 and Plexiglas front 64 have been removed to expose an interior 80 of the feeding system 62. A reader 81 is located at the front 64. Preferably, the reader is a scanner. The reader identifies the particular animal that is approaching the feeding system.

Cross members 82, 84 provide support to the sides 72 and discs 86 are rotatably mounted on each side 72 at the rear 78. The rotatable discs 86 are powered by servo motors 88. The servo motors are controlled by the processor (not shown in FIG. 15) to open and close the door 66 (not shown in FIG. 15) to allow or prevent access respectively to the container

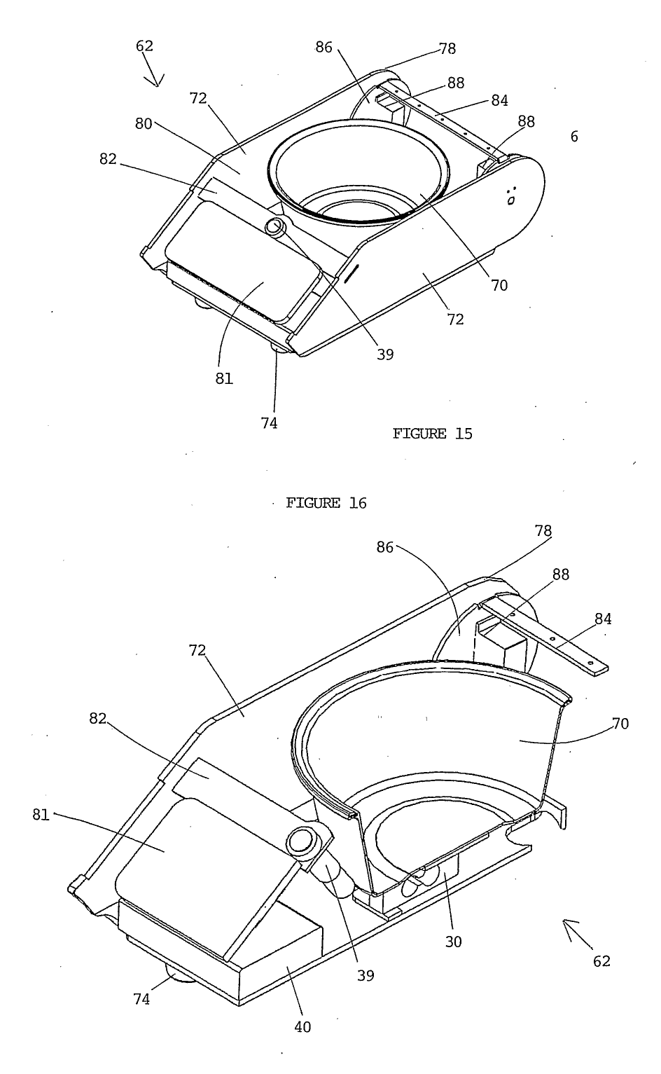

In FIG. 16, there is shown a partial perspective view of the feeding system 62. A programmable processor 40 is located behind the reader 81. The reader sends signals to the processor. It can be seen that the container 70 is mounted on a load cell 30 to weigh the feed (not shown) within the container 70. The load cell 30 provides output signals to the processor (not shown in FIG. 16) which stores information from the load cell in memory. The same reference numerals are used in FIGS. 14, 15 and 16 as those used in FIGS. 12 and 13 to describe those components that are identical.

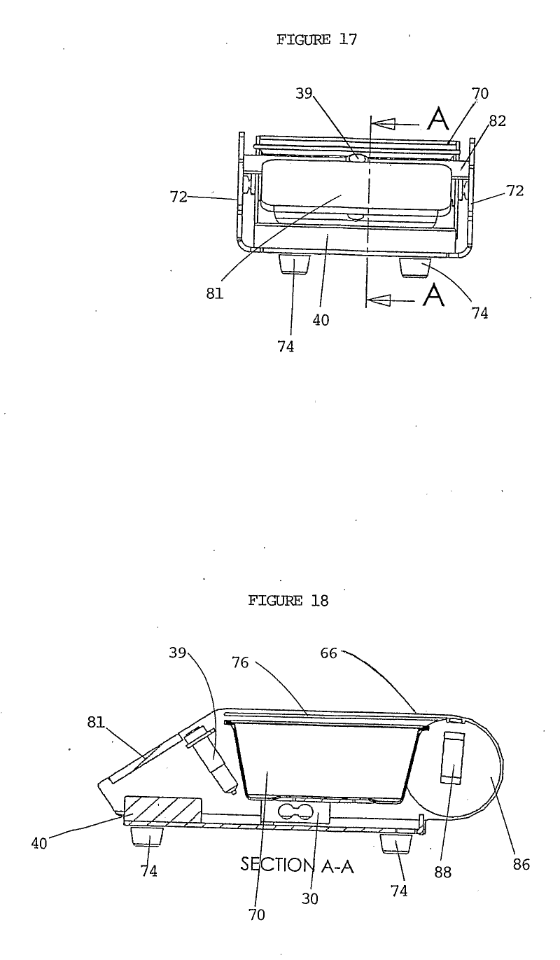

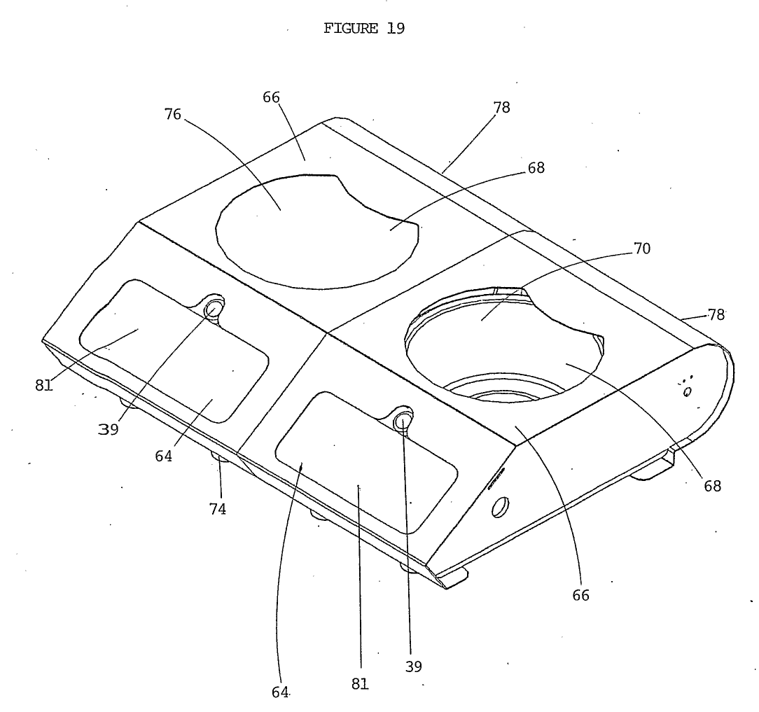

In FIGS. 17 and 18, it can be seen that the sensor 39 is mounted in the front 64 of the system 62 at an angle. The sensor 39 determines whether the system is operating properly. The reader 81 identifies the animal that is approaching the system 62. The cover 76 slides beneath the top surface 66 to close off the opening 68 as shown in FIG. 18. In the open position, the cover 76 is retracted by the rotation of the discs 86 and is flexible enough to be formed into a roll around the discs 86. The processor 40 controls the system to open and close the door as required. The same reference numerals are used in FIGS. 17 and 18 as those used in FIGS. 12 to 16 to describe those components that are identical.

In FIG. 19, there are two systems 62 (not shown in FIGS. 17 and 18) attached to one another. Preferably, the systems have suitable plug-ins so that they can easily be attached to one another or detached from one another, as desired. When two systems are attached to one another, the resulting system has two containers 70 and, except for the weighing station and the ability to record which container is first approached, has essentially the same function as the feeding system 2 shown in FIGS. 1 to 11. The resulting system from the attachment of the two separate systems will have two processors The processors are programmed so that one of the processors will take priority and will operate the resulting system which has two containers, two readers and two sensors. The resulting feeding system can be used to feed several animals where it is desired to feed them two different types of food. Also, the resulting system with its two containers can be used to feed cats from one container and dogs from the other container.

The tunnel 10 of the feeding system 2 is primarily designed for use by cats, but a similar tunnel can be designed for use by dogs. The feeding system 2 can be designed with two tunnels, one for use by cats and one for use by dogs so that the same feeding system can be used to feed both cats and dogs.

The feeding system 62 described in FIGS. 12 to 19 is designed for use by cats or dogs or by both cats and dogs. Preferably, the system would always have at least two bowls or containers as shown in FIG. 19. Preferably bowls are inserted into the containers and the feed is inserted into the bowls. The bowls act as a liner for the containers and are more easily cleaned than the containers. The bowls can be removed from the system and replaced at any time. A user could have more than one set of bowls and remove one set when the bowls are empty or nearly empty and replace those bowls with pre-filled bowls. The system 62 is also wired to allow a weigh station to be plugged into the system so that the animals are automatically weighed before and after eating. Both the covers 32 and the door or doors 76 are designed to retract in the event that they contact an obstruction when closing in order to ensure that the animals are not injured by the closing of the covers or doors. The speed of closing of the covers or doors is controlled by the processor and can be varied through the software that runs the processor. Preferably, the scanner or reader used in the feeding stations of the present invention is adjusted so that it does not move the covers or doors to the open position until an animal is approximately twenty to thirty centimeters away from the entrance to the system. This short distance will ensure that the wrong animal does not exercise access to the system when the system opens to accommodate a different animal. The doors 76 can also be referred to as gates. The sensors 38 also confirm that an animal is accessing the feeding system.

The feeding system 2 is primarily a commercial system whereas the feeding system 62 is primarily designed for use in a residence. While it is not shown in the drawings, there is a cone affixed to the top of the load cell that fits into a cone shaped receptacle in the bottom of each of the containers 24, 26. The containers are placed onto the load cells by aligning the receptacles of each container with the cones.

Preferably, a proximity switch senses a subject animal entering the feeding station. The Plexiglas shields and protects the scanner or proximity switch.

In summary, the automatic feeding system of the present invention is able to control when each animal can eat, the feed times for each animal, the amount of feed that each animal is allowed to consume and has consumed, the food source or food sources that will be accessible to each animal (i.e. the type of food), the body weight of each animal as it eats. The processor can adjust the door speed, the amount of time that the door stays open and control the number of times that each animal is allowed to eat each day.

With proximity meters and photocells that are electronically connected into the system, the system of the present invention can also monitor which feed source each particular animal approaches first and which feed source each animal consumes first. By using photocells and proximity meters that are connected into the automatic feeding system, the system is able to monitor the location of other animals within the feeding area. The proximity meters and photocells comprise a monitor. Preferably, the cameras are infrared cameras so that night feeding behaviour can be recorded.

The number of animals that can be controlled by the system will vary with the capacity of the processor, the capacity of the containers used and the type of animal. For example, an automatic feeding system in accordance with the present invention might be used to control and monitor the feeding of ten or more cats. Alternatively, cats and dogs can be controlled and monitored by the same system with the dog food being made available through one feed source and the cat food being made available through another feed source. If one animal is overweight, the system could be used to deny access to that animal completely for a given period of time or to shorten the period of access that the animal will be allowed to feed.

Preferably, bar codes are used to monitor and identify the feed sources. Bowls are filled and taken to feeding stations with a handheld wireless scanner, the station is scanned, the first bowl is scanned and a scale is scanned for verification of the diet placement. When the series of bar codes is matched with the components, the first bowl is placed on the scale. The same procedure is used for the second food source.

The automatic feeding stations can be set up to be controlled online as well. Wired scanners can be used or wireless hand scanners can be used to calibrate the scales, check door function, check proximity meter or photocell function, check the station mode, for example, normal, waiting or training. Different procedures will be used by the automatic feeding system in the waiting or training mode than in the normal mode. The size and configuration of the feeding station will vary with the number and type of animals that are using the system. For example, instead of controlling access to the food sources by causing the covers to rotate on the containers or bowls, access can be controlled by having an opening in the housing for each food source with a door or gate that is electronically controlled to open and close the opening. The design of the door or gate will likely be different for cats than it is for dogs or other animals. The doors or gates will preferably have safety controls so that the door or gate will temporarily release rather than injure an animal.

It may also be desirable in some applications to have an electronic gate to discourage an animal from accessing the food source at particular times. The door, gates or covers are barriers that restrict access to the food sources by the animals.

Preferably, the identification device is a microchip that is implanted in each animal. When dogs are using the system, the doors that control access to each food source will preferably be designed to move up and down. For cats, the doors are preferably hinged or rotatable covers are used. When both dogs and cats are fed through the same feeding station the dogs will not be able to access the food that is intended for the cats and vice-versa. While the system is shown with only two feed sources, any reasonable number of food sources can be used. Two or more feeding systems can be connected together to provide one large system controlled by one processor or computer system.

The system of the present invention can be used to test the acceptance of newly created food mixtures or types of food by monitoring the reaction of the animals. In other words, the animals themselves can be monitored to determine the choice of food that the animals prefer. A modem or LAN can be used with the system to allow the system to be remotely configured and controlled.

The system can be used to allow one animal to eat whenever it wishes to do so and to strictly control the eating habits of another animal, which might be overweight. The feeding system comprises a feeding station. One feeding station can be used to feed dogs and another feeding station, within the same room can be used to feed cats. Alternatively, where the feeding stations within the same room are independent from one another, certain animals of the entire group of animals can be fed from one station and other animals can be fed from another station. The animals will soon learn which feeding station is accessible to them. Since one does not wish to have the animals wait for one another to eat, the number of animals being fed by a single feeding station with one or two feed sources is limited. With the feeding system 2 or the feeding system 62 with two bowls as shown in FIG. 19 representing one feeding station, a feeding station of the present invention can easily feed ten cats. The system operates automatically as long as there is sufficient feed within the feed sources. The system must be shut down from time to time in order to replenish the containers.

I claim:

1. A method of automatically feeding animals using an electronic feeding system having a feeding station with at least one controlled access food source, said station being controlled by a programmable processor, said method comprising locating an electronic identification device on each animal to enable each animal to be individually identified by said system, placing at least one feed source in a controlled access location, programming said processor to control the feeding of each animal, storing information from each feeding for each animal, using said stored information to control and monitor each feeding for each animal, controlling an amount of feed that can be consumed based on the identification of each animal.

2. A method of feeding animals using an electronic system having a feeding station with at least one feed source, said station being controlled by a programmable processor, said method comprising locating an electronic locating device on each animal to enable each animal to be individually identified by said system, placing said at least one feed source in a controlled access location, controlling access to said at least one feed source by each animal separately, storing information from each feeding by each animal, and using stored information for a subsequent feeding.

3. A method of feeding animals using an electronic system having a feeding station with one or more controlled access feed sources, said station being controlled by a programmable processor, said method comprising locating electronic identification devices on each animal to enable each animal to be identified individually by said system, placing said one or more feed sources in a controlled access area of said system, locating an access barrier for each feed source, programming said processor to allow access to a particular feed source or feed sources by a particular animal or animals, controlling said access, controlling an amount of each feed source consumed by each animal by opening and closing said barrier or barriers, storing the information for each feeding for each animal, using said information to control future feeding.

4. A method as claimed in claim 3 wherein there are at least two controlled access feed sources and said method includes the steps of controlling a type of food consumed by each animal.

5. A method as claimed in claim 1 wherein there are two or more feed sources, said method including the steps of controlling a number of feed sources that a particular animal has access to.

6. A method as claimed in claim 1 including the step of programming said processor to cut off access for a particular animal when that animal has reached a pre-determined amount of food for that feeding.

7. A method as claimed in any one of claims 1, 2, or 3 wherein there is a memory for said processor, said method including the steps of storing information for each animal in said memory.

8. A method as claimed in any one of claims 1 or 2 wherein said system has electronic gates thereon for each feed source, said method including the steps of controlling an opening and closing of said gates for each animal and for each feed source.

9. A method as claimed in claim 1 wherein said system has an output and said method includes the step of outputting information stored within said system to said output.

10. A method as claimed in claim 3 wherein said barriers are gates and said method including the steps of opening and closing each gate.

11. A method as claimed in any one of claims 1,2 or 3 wherein there is a memory and a sensor on said system, said method including the steps of operating said sensor to record first approaches to each feed source in said memory.

12. A method as claimed in any one of claims 1, 2 or 3 wherein there is a memory and a sensor on said system, said method including the steps of operating said sensor to record first tastes of each feed source in said memory.

13. An automatic feeding system for animals comprising a feeding station with at least one feed source, said station being controlled by a programmable processor, said animals having individual identifiers mounted thereon, said feed source being located in a controlled access area, said access being controlled by a gate, there being one gate for each feed source, said processor controlling each gate, said processor identifying each animal and opening and closing each gate for each feed source to allow access or prevent access to each feed source for each animal, determining a type and amount of each feed source consumed by each animal, storing information from said determination in a memory, said processor controlling each gate based on said information for each animal.

14. A system as claimed in claim 13 wherein said identifiers are embedded beneath the skin of each animal.

15. A system as claimed in claim 13 wherein said processor has an output electronically connected thereto.

16. A system as claimed in claim 15 wherein said processor is a computer.

17. A system as claimed in claim 13 wherein there is a memory on said processor, said processor being connected to record at least one of first approaches and first tastes of each feed source.

18. A system as claimed in claim 13 including load cells connected to monitor a weight of each fed source.

19. A system as claimed in claim 18 including a load cell to monitor a weight of each animal when said animal enters or exits said system.

20. A method of automatically feeding animals using an electronic system having a feeding station with one or more controlled access feed sources, said station being controlled by a programmable processor, said programmable processor being connected to a reader, said reader being capable of identifying a distinct feature of each animal, said animals each having a distinct feature that can distinguish the animals from each other, said method comprising pre-programming a feeding program for each animal, using said reader to identify each animal that approaches said station, placing said one or more feeding stations in a controlled access area of said system, locating an access barrier for each feed source, automatically controlling access to said feed sources for each animal in accordance with said feeding program for each animal including the type and amount of feed consumed by opening and closing said barrier or barriers appropriately and storing information for each feeding for each animal.

21. A method as claimed in claim 20 including the steps of using at least one means of identifying each animal selected from the group of an unique identifier attached to each animal, an implant to identify each animal, a retina scan and an iris scan.

22. A method as claimed in claim 20 including using a scanner for said reader.

23. A method as claimed in claim 20 wherein there are two or more feed sources, said method including the steps of controlling a number of feed sources that a particular animal has access to.

24. A method as claimed in claim 20 including the step of programming said processor to feed each animal.

25. A method as claimed in claim 20 wherein there is a memory for said processor, said method including the steps of storing information for each animal in said memory.

26. A method as claimed in claim 20 wherein a computer is connected to said processor, said method including the steps of downloading information from said computer to said processor and receiving information from said processor in said computer.

27. A method as claimed in claim 20 wherein said system contains a modem, said method including the steps of passing information to and from said system remotely through said modem.

28. A method as claimed in claim 20 wherein said system is connected into a local area network, said method including the steps of passing information to and from said system within said local area network.

29. A method as claimed in claim 20 wherein there is a memory and a sensor on said system, said method including the steps of operating said sensor to record first tastes of each food source in said memory.

30. An automatic feeding system for animals comprising a feeding station with at least one feed source, said animals each having a distinct feature that can distinguish said animals from each other, said feeding station being controlled by a programmable processor, said programmable processor being connected to a reader, said reader being capable of identifying said distinct feature of each animal, said processor controlling access to said at least one feed source by each animal based on information for each animal, said system being constructed to open and close a barrier between said animals and said at least one feed source, said system having a memory to store information for each animal for several feedings.

31. An automatic feeding system as claimed in claim 30 wherein said barrier is selected from the group of covers, doors, physical gates and electronic gates.

32. An automatic feeding system as claimed in claim 30 wherein said reader is connected to conduct at least one of a retina scan and an iris scan on each animal to identify and distinguish each animal from other animals.

33. An automatic feeding system as claimed in claim 30 wherein said processor has an output electronically connected thereto to output information from said processor to a computer connected to said output.

34. An automatic feeding system as claimed in claim 30 wherein said processor is a computer.

35. An automatic feeding system as claimed in claim 30 wherein there is a sensor on said system and a memory on said processor, said sensor being connected to determine at least one of first approaches and first tastes of each food source, said processor recording information from said sensor in said memory.
